(19) United States
(12) Patent Application Publication
(10) Pub. No.: US 2022/0315815 A1
(43) Pub. Date: Oct. 6, 2022

(54) ADHESIVE COMPOSITION AND DISPLAY APPARATUS INCLUDING THE SAME

(71) Applicant: SAMSUNG DISPLAY CO., LTD., Yongin-si (KR)

(72) Inventors: Kyungmi Kwon, Yongin-si (KR); Bookan Ki, Yongin-si (KR); Hoyun Byun, Yongin-si (KR)

(21) Appl. No.: 17/569,137

(22) Filed: Jan. 5, 2022

(30) Foreign Application Priority Data
Apr. 5, 2021 (KR) 10-2021-0044299

(51) Int. Cl. C09J 175/04; C09J 133/08; C08F 220/18; C08G 18/75

(52) U.S. Cl. CPC C09J 175/04; C09J 133/08; C08F 220/1811; C08F 220/1808; C08G 18/755; C09J 2203/318; C09J 2301/30; C09J 2475/00; C09J 2433/00

(57) ABSTRACT

A display apparatus includes a display panel, a cover window above the display panel, and an adhesive layer between the display panel and the cover window. The adhesive layer includes: (meth)acrylate having an alicyclic group, (meth)acrylate having a glass transition temperature of about 40° C. or less, cross-linkable (meth)acrylate, and a thermal curing agent including an isocyanate-based compound. The adhesive composition has a first elastic modulus at a first temperature and a second elastic modulus at a second temperature greater than the first temperature, and the second elastic modulus is equal to or greater than the first elastic modulus.

This application claims priority to Korean Patent Application No. 10-2021-0044299, filed on Apr. 5, 2021, and all the benefits accruing therefrom under 35 U.S.C. § 119, the content of which in its entirety is herein incorporated by reference.

### BACKGROUND

### 1. Field

One or more embodiments relate to an adhesive composition and a display apparatus, and more particularly, to an adhesive composition having improved reliability with respect to penetrating bubbles, and a display apparatus including the adhesive composition.

### 2. Description of the Related Art

A display apparatus has been used in a greater variety of ways. In addition, the display apparatus has become thinner and lighter in weight, and thus, their range of use has widened. As the use of the display apparatus has diversified, various methods for designing forms of the display apparatus have been studied.

In the display apparatus, a cover window for protecting substructures is above a display panel, and an optically clear adhesive (“OCA”) is used to join together the display panel and the cover window. The OCA should basically have excellent moisture resistance, heat resistance, and adhesion as well as optical properties.

### SUMMARY

One or more embodiments include an adhesive composition having improved reliability with respect to penetrating bubbles and a display apparatus including the adhesive composition. However, such a solution to a problem is merely an example, and thus, the disclosure is not limited thereto.

Additional aspects will be set forth in part in the description which follows and, in part, will be apparent from the description, or may be learned by practice of the presented embodiments of the disclosure.

According to one or more embodiments, an adhesive composition includes (meth)acrylate having an alicyclic group, (meth)acrylate having a glass transition temperature of about 40 degrees in Celsius (° C.) or less, cross-linkable (meth)acrylate, and a thermal curing agent including an isocyanate-based compound, where the adhesive composition has a first elastic modulus at a first temperature and a second elastic modulus at a second temperature greater than the first temperature, and the second elastic modulus is equal to or greater than the first elastic modulus.

An amount of the (meth)acrylate having the alicyclic group may be about 5 percentages by weight (wt %) to about 15 wt %.

An amount of the (meth)acrylate having the glass transition temperature of about 40° C. or less may be about 15 wt % to about 25 wt %.

An amount of the cross-linkable (meth)acrylate may be about 5 wt % to about 15 wt %.

An amount of the thermal curing agent may be about 55 wt % to about 65 wt %.

In the adhesive composition, a ratio between the first elastic modulus at about 25° C. and the second elastic modulus at about 60° C. may satisfy Equation below:

Second elastic modulus/first elastic modulus≥1. [Equation]

In the adhesive composition, a change in stress between about 1 second and about 5 seconds according to stress-relaxation characteristics at about 60° C. may be less than about 470 pascals per second (Pa/s).

The cross-linkable (meth)acrylate may be a (meth)acrylate monomer having an alkyl group of 1 to 12 carbon atoms.

The isocyanate-based compound may include at least one of an aliphatic isocyanate-based compound, an alicyclic isocyanate-based compound, and an aromatic isocyanate-based compound.

A curing rate of the adhesive composition may be about 95 percentages (%) or greater.

According to one or more embodiments, a display apparatus includes: a display panel, a cover window above the display panel, and an adhesive layer between the display panel and the cover window. The adhesive layer includes: (meth)acrylate having an alicyclic group, (meth)acrylate having a glass transition temperature of about 40° C. or less, cross-linkable (meth)acrylate, and a thermal curing agent including an isocyanate-based compound, where the adhesive layer has a first elastic modulus at a first temperature and a second elastic modulus at a second temperature greater than the first temperature, and the second elastic modulus is equal to or greater than the first elastic modulus.

An amount of the (meth)acrylate having the alicyclic group may be about 5 wt % to about 15 wt %.

An amount of the (meth)acrylate having the glass transition temperature of about 40° C. or less may be about 15 wt % to about 25 wt %.

An amount of the cross-linkable (meth)acrylate may be about 5 wt % to about 15 wt %.

An amount of the thermal curing agent may be about 55 wt % to about 65 wt %.

In the adhesive layer, a ratio between the first elastic modulus at about 25° C. and the second elastic modulus at about 60° C. may satisfy Equation below:

Second elastic modulus/first elastic modulus≥1. [Equation]

In the adhesive layer, a change in stress between about 1 second and about 5 seconds according to stress-relaxation characteristics at about 60° C. may be less than about 470 Pa/s.

A thickness of the adhesive layer may be about 50 micrometers (μm) to about 300 μm.

A curing rate of the adhesive layer may be about 95% or greater.

According to one or more embodiments, an adhesive composition has a first elastic modulus at a first temperature and a second elastic modulus at a second temperature greater than the first temperature, where the second elastic modulus is equal to or greater than the first elastic modulus.

The first temperature may be about 25° C., and the second temperature may be about 60° C.

In the adhesive composition, a change in stress between about 1 second and about 5 seconds according to stress-relaxation characteristics at about 60° C. may be less than about 470 Pa/s.

The adhesive composition may be urethane-based or acrylic-based.

These general and specific embodiments may be implemented by using a system, a method, a computer program, or a combination of the system, the method, and the computer program.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1 and 2 are schematic cross-sectional views of an electronic device including a display apparatus according to an embodiment;

FIGS. 3 and 4 are schematic plan views of an electronic device including a display apparatus according to an embodiment;

FIG. 5 is a schematic plan view of a display panel according to an embodiment;

FIG. 6 is an equivalent circuit diagram of a pixel according to an embodiment;

FIG. 7 is a schematic cross-sectional view of a stacked structure of a display panel according to an embodiment;

FIG. 8 is a table of measurement of an elastic modulus according to temperature and penetrating bubbles of an adhesive composition according to an embodiment and comparative examples;

FIG. 9 is a graph showing an elastic modulus ratio according to temperature of an adhesive composition according to an embodiment and comparative examples;

FIG. 10 is a table showing results of measuring the incidence of penetrating bubbles according to a composition ratio of an adhesive composition according to an embodiment and comparative examples;

FIGS. 11 and 12 are graphs comparatively measuring changes according to stress-relaxation characteristics of an adhesive composition according to an embodiment and comparative examples;

FIG. 13 is a table showing results of measuring the incidence of penetrating bubbles according to a composition ratio of the adhesive composition according to each embodiment and the comparative examples shown in FIG. 12; and

FIGS. 14 and 15 are tables showing experimental results according to the occurrence of penetrating bubbles of an embodiment including an adhesive composition according to an embodiment and comparative examples.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

As the present description allows for various changes and numerous embodiments, certain embodiments will be illustrated in the drawings and described in the written description. Effects and features of one or more embodiments and methods of accomplishing the same will become apparent from the following detailed description of the one or more embodiments, taken in conjunction with the accompanying drawings. However, the present embodiments may have different forms and should not be construed as being limited to the descriptions set forth herein.

One or more embodiments will be described below in more detail with reference to the accompanying drawings. Those elements that are the same or are in correspondence with each other are rendered the same reference numeral regardless of the figure number, and redundant descriptions thereof are omitted.

While such terms as “first” and “second” may be used to describe various elements, such elements must not be limited to the above terms. The above terms are used to distinguish one element from another.

The singular forms “a,” “an,” and “the” as used herein are intended to include the plural forms as well unless the context clearly indicates otherwise.

It will be understood that the terms “include,” “comprise,” and “have” as used herein specify the presence of stated features or elements but do not preclude the addition of one or more other features or elements.

It will be further understood that, when a layer, region, or element is referred to as being on another layer, region, or element, it may be directly or indirectly on the other layer, region, or element. That is, for example, intervening layers, regions, or elements may be present.

It will be further understood that, when layers, regions, or elements are referred to as being connected to each other, they may be directly connected to each other or indirectly connected to each other with intervening layers, regions, or elements therebetween. For example, when layers, regions, or elements are referred to as being electrically connected to each other, they may be directly electrically connected to each other or indirectly electrically connected to each other with intervening layers, regions, or elements therebetween.

As used herein, the expression “A and/or B” refers to A, B, or A and B. In addition, the expression “at least one of A and B” refers to A, B, or A and B. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

The x-axis, the y-axis, and the z-axis are not limited to three axes of the rectangular coordinate system and may be interpreted in a broader sense. For example, the x-axis, the y-axis, and the z-axis may be perpendicular to one another or may represent different directions that are not perpendicular to one another.

When an embodiment may be implemented differently, a certain process order may be performed differently from the described order. For example, two consecutively described processes may be performed substantially at the same time or performed in an order opposite to the described order.

Sizes of elements in the drawings may be exaggerated or reduced for convenience of description. In other words, since sizes and thicknesses of elements in the drawings are arbitrarily illustrated for convenience of description, the following embodiments are not limited thereto.

In the present description, although an organic light-emitting display apparatus is described as an example of a display apparatus according to an embodiment, a display apparatus described herein is not limited thereto. In another embodiment, the display apparatus described herein may be a display apparatus such as an inorganic light-emitting display apparatus (or an inorganic electroluminescent (“EL”) display apparatus) or a quantum dot light-emitting display apparatus. For example, an emission layer of a display element included in the display apparatus may include an organic material, may include an inorganic material, may include quantum dots, may include an organic material and quantum dots, or may include an inorganic material and quantum dots.

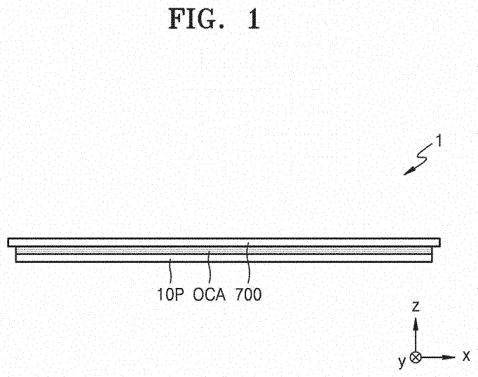

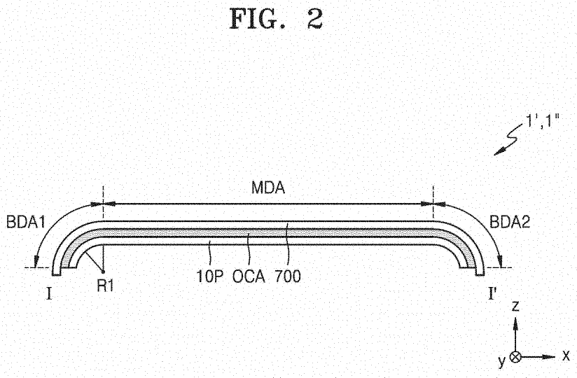

FIGS. 1 and 2 are schematic cross-sectional views of an electronic device including a display apparatus 1, 1′, and 1″ according to an embodiment.

Referring to FIGS. 1 and 2, the display apparatus 1, 1′, and 1″ according to an embodiment may include a display panel 10P and a cover window 700 for protecting an upper portion of the display panel 10P. The display apparatus 1, 1′, and 1″ may generally have a flat shape as shown in FIG. 1, or may have a shape in which at least some areas are bent as shown in FIG. 2.

In the display apparatus 1′ and 1″ of FIG. 2, a display area DA may include a main display area MDA, and a first bending display area BDA1 and a second bending display area BDA2, which are bending areas. The first bending display area BDA1 and the second bending display area BDA2 may be bent to have a curvature radius R1. Although FIG. 2 shows the first bending display area BDA1 and the second bending display area BDA2 having the same curvature radius R1 each other, in another embodiment, the first bending display area BDA1 and the second bending display area BDA2 may have different curvature radii from each other.

The display apparatus 1, 1′ and 1″ may include an adhesive layer OCA between the display panel 10P and the cover window 700 to join together the display panel 10P and the cover window 700. The adhesive layer OCA may have the same width and the same area as the display panel 10P.

During a process of attaching the display panel 10P and the cover window 700 to each other through the adhesive layer OCA, a pressurization process, for example, an autoclave process, may be performed on the adhesive layer OCA. The autoclave process may be a process of applying pressure (e.g., 8 bar) to remove bubbles in a bending area under high temperature (e.g., 60 degrees in Celsius (° C.)). After the autoclave process in high-temperature and high-pressure conditions is completed, the display apparatus 1, 1′, and 1″ returns to room temperature and atmospheric pressure conditions (e.g., 25° C., bar).

In this regard, as a comparative example, as ambient temperature and pressure decrease after the autoclave process, re-penetration of bubbles may occur in an adhesive layer. Hereinafter, these bubbles will be defined as ‘penetrating bubbles’. As described above, penetrating bubbles may refer to bubbles that occur in the adhesive layer OCA after attaching the adhesive layer OCA during the manufacturing process. Penetrating bubbles may occur in the adhesive layer OCA itself as temperature and pressure in the adhesive layer OCA decrease after attachment of the adhesive layer OCA, or may occur as external air penetrates.

Such penetrating bubbles are more vulnerable in an edge area or a bending area of a display apparatus. It is understood that penetrating bubbles are recognized as penetrating bubbles in an edge portion where an edge area or a bending area of a display apparatus is formed because bubbles trapped in an adhesive layer fail to escape and become cohesive when a gas dissolved in the adhesive layer under high-temperature and high-pressure pressurization process conditions (e.g., 60° C., 8 bar) returns to room temperature and atmospheric pressure (e.g., 25° C., 1 bar) after completion of the pressurization process.

Accordingly, in the adhesive layer OCA provided to attach the cover window 700 to the display panel 10P, reliability of the adhesive layer OCA may be significant particularly in the edge area or the bending area.

Thus, the display apparatus 1, 1′, and 1″ according to an embodiment includes the adhesive layer OCA and an adhesive composition in which the occurrence of penetrating bubbles described above is effectively reduced. As a result, by preventing penetrating bubbles from occurring even after completion of the pressurization process, a defect rate in an edge area or a bending area of the display apparatus 1, 1′, and 1″ may be decreased, and reliability of the display apparatus 1, 1′, and 1″ may be improved.

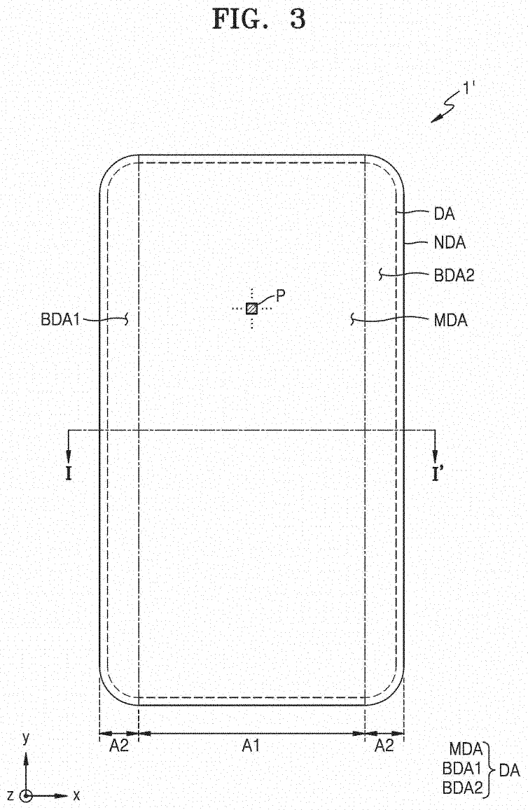

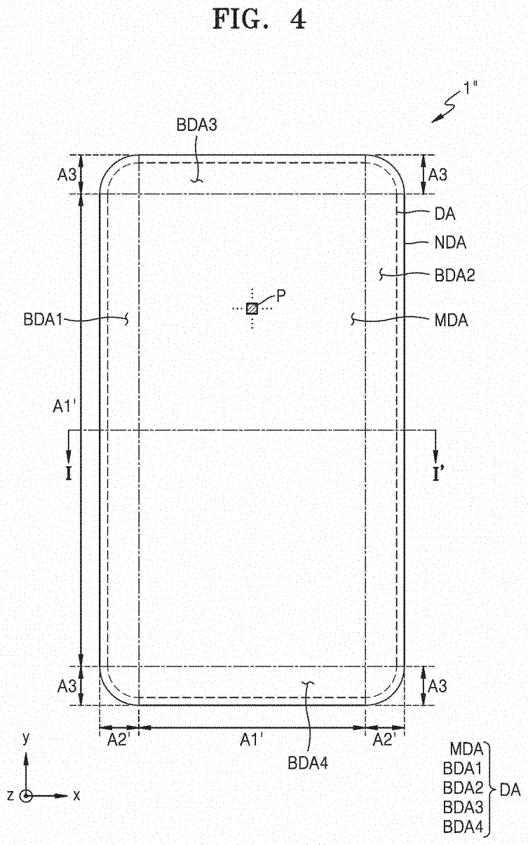

FIGS. 3 and 4 are schematic plan views of an electronic device including the display apparatus 1′ and 1″ according to an embodiment.

Referring to FIGS. 3 and 4, the display apparatus 1′ and 1″ includes the display area DA and a peripheral area NDA outside the display area DA. A plurality of pixels P including display elements may be arranged in the display area DA, and the display apparatus 1′ and 1″ may provide an image by using light emitted from the plurality of pixels P arranged in the display area DA. The peripheral area NDA is a non-display area in which no display element is arranged, and the display area DA may be entirely surrounded by the peripheral area NDA.

Although FIGS. 3 and 4 show a case in which the display area DA of the display apparatus 1′ and 1″ has a quadrilateral shape with rounded corners, in another embodiment, a shape of the display area DA may be a circle, an oval, or a polygon such as a triangle or a pentagon.

Although FIGS. 3 and 4 show the flat display apparatus 1′ and 1″ before bending, the display apparatus 1′ and 1″ according to the present embodiment may include a three-dimensional display surface or a curved display surface as shown in FIG. 2. That is, the above-described FIG. 2 may correspond to a cross-section of bent bending display areas, for example, first to fourth bending display areas BDA1 to BDA4, of the display apparatus 1′ and 1″ of FIG. 3 or FIG. 4, taken along line I-I′.

When the display apparatus 1′ and 1″ includes a three-dimensional display surface, the display apparatus 1′ and 1″ may include a plurality of display areas oriented in different directions from one another, and for example, may include a polyprism-shaped display surface. In another embodiment, when the display apparatus 1′ and 1″ includes a curved display surface, the display apparatus 1′ and 1″ may be implemented in various forms such as flexible, foldable, and rollable display apparatuses.

The display apparatus 1′ of FIG. 3 may include a first area A1 and second areas A2 arranged on opposite sides of the first area A1, respectively. The first area A1 may be, for example, a non-bending area, and the second areas A2 may be bending areas bent to have a preset curvature. When the display apparatus 1′ has a bending area, it may mean that layers constituting the display apparatus 1′ each have a bending area.

According to an embodiment, the display area DA may include the main display area MDA corresponding to the first area A1, and the first bending display area BDA1 and the second bending display area BDA2 corresponding to the second areas A2, respectively.

The display apparatus 1″ of FIG. 4 may include a first area A1′, and second areas A2′ and third areas A3 respectively arranged on four edge sides of the first area A1′. The first area A1′ may be, for example, a non-bending area, and the second areas A2′ and the third areas A3 may be bending areas that may be bent to have a preset curvature. The second areas A2′ may be arranged on left and right sides of the first area A1′ and may be bent with respect to a bending axis in a long-axis direction, and the third areas A3 may be arranged on upper and lower sides of the first area A1′ and may be bent with respect to a bending axis in a short-axis direction. Accordingly, a display apparatus having a four-sided bending structure may be manufactured.

According to an embodiment, the display area DA may include the main display area MDA corresponding to the first area A1′, the first bending display area BDA1 and the second bending display area BDA2 corresponding to the second areas A2′, respectively, and the third bending display area BDA3 and the fourth bending display area BDA4 corresponding to the third areas A3, respectively. The first to fourth bending display areas BDA1 to BDA4 may be bent to face different directions from one another.

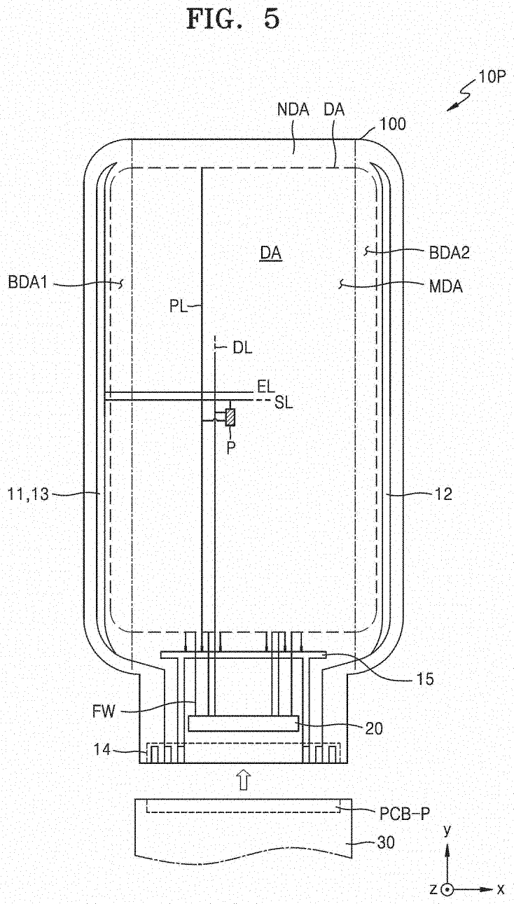

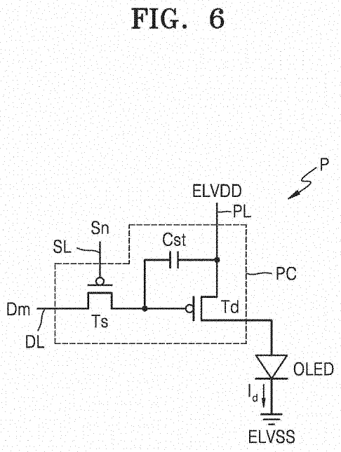

FIG. 5 is a schematic plan view of the display panel 10P according to an embodiment. FIG. 6 is an equivalent circuit diagram of a pixel P according to an embodiment.

Referring to FIG. 5, the display panel 10P includes a substrate 100, and various elements constituting the display panel 10P are arranged on the substrate 100.

The display area DA may include the main display area MDA, which is a non-bending area, and the first and second bending display areas BDA1 and BDA2, which are bending areas adjacent to the non-bending area. The first and second bending display areas BDA1 and BDA2 may be arranged on opposite sides of the main display area MDA, respectively. That is, the first and second bending display areas BDA1 and BDA2 may be adjacent to first and second scan driving circuits 11 and 12.

The plurality of pixels P may be arranged in the display area DA. Each of the plurality of pixels P may include at least one sub-pixel and may be implemented by a display element such as an organic light-emitting diode OLED. The plurality of pixels P may emit, for example, red, green, blue, or white light.

The plurality of pixels P arranged in the display area DA may be electrically connected to outer circuits arranged in the peripheral area PA, which is a non-display area. The first scan driving circuit 11, the second scan driving circuit 12, an emission control driving circuit 13, a terminal 14, and a first power supply line 15 may be arranged in the peripheral area NDA. Although not shown, a second power supply line may be arranged on an outer region of driving circuits, for example, the first scan driving circuit 11, the second scan driving circuit 12, and the emission control driving circuit 13.

The first scan driving circuit 11 may provide scan signals to the plurality of pixels P through a scan line SL. The second scan driving circuit 12 may be parallel to the first scan driving circuit 11 with the display area DA therebetween. Some of the plurality of pixels P arranged in the display area DA may be electrically connected to the first scan driving circuit 11, and the others may be connected to the second scan driving circuit 12. In another embodiment, the second scan driving circuit 12 may be omitted.

The emission control driving circuit 13 may be arranged on the side of the first scan driving circuit 11 and may provide an emission control signal to the pixel P through an emission control line EL. Although FIG. 5 shows the emission control driving circuit 13 arranged on only one side of the display area DA, the emission control driving circuit 13 may be arranged on opposite sides of the display area DA on which the first and second scan driving circuits 11 and 12 are.

The terminal 14 may be arranged in the peripheral area NDA of the substrate 100. The terminal 14 may not be covered by an insulating layer but may be exposed and be electrically connected to a printed circuit board 30. A terminal PCB-P of the printed circuit board 30 may be electrically connected to the terminal 14 of the display panel 10P.

The printed circuit board 30 transmits a signal or power of a controller (not shown) to the display panel 10P. Control signals generated by the controller may be transmitted to driving circuits, for example, the first scan driving circuit 11, the second scan driving circuit 12, and the emission control driving circuit 13, respectively, through the printed circuit board PCB. Also, the controller may provide a driving voltage ELVDD to the first power supply line 15 and may provide a common voltage ELVSS to the second power supply line. The driving voltage ELVDD may be provided to the pixel P through a driving voltage line PL connected to the first power supply line 15, and the common voltage ELVSS may be provided to an opposite electrode of a pixel connected to the second power supply line. The first power supply line 15 may extend in one direction (e.g., a direction x) at a lower side of the display area DA. The second power supply line may have a loop shape with one side open and may be arranged in the peripheral area NDA.

Also, the controller may generate a data signal, and the generated data signal may be transmitted to an input line FW through a data pad portion 20 and may be transmitted to the pixel P through a data line DL connected to the input line FW.

Referring to FIG. 6, each pixel P includes a pixel circuit PC connected to the scan line SL and the data line DL, and the organic light-emitting diode OLED connected to the pixel circuit PC.

The pixel circuit PC includes a driving thin-film transistor Td, a switching thin-film transistor Ts, and a storage capacitor Cst. The switching thin-film transistor Ts is connected to the scan line SL and the data line DL and is configured to transmit a data signal Dm input through the data line DL to the driving thin-film transistor Td according to a scan signal Sn input through the scan line SL.

The storage capacitor Cst is connected to the switching thin-film transistor Ts and the driving voltage line PL and stores a voltage corresponding to a difference between a voltage received from the switching thin-film transistor Ts and the driving voltage ELVDD supplied to the driving voltage line PL.

The driving thin-film transistor Td may be connected to the driving voltage line PL and the storage capacitor Cst and may be configured to control a driving current flowing through the organic light-emitting diode OLED from the driving voltage line PL in response to a voltage value stored in the storage capacitor Cst. The organic light-emitting diode OLED may emit light having certain brightness according to a driving current Id.

Although FIG. 6 shows a case in which the pixel circuit PC includes two thin-film transistors and one storage capacitor, the disclosure according to the invention is not limited thereto. In another embodiment, the pixel circuit PC may include seven thin-film transistors and one storage capacitor. In another embodiment, the pixel circuit PC may include two or more storage capacitors.

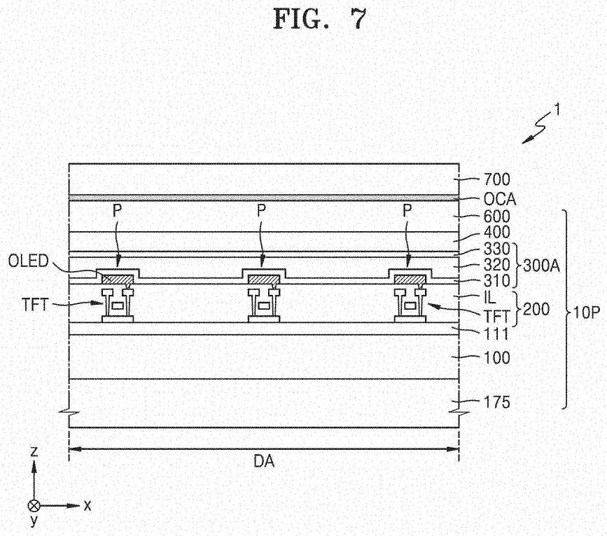

FIG. 7 is a schematic cross-sectional view of a stacked structure of the display panel 10P according to an embodiment.

Referring to FIG. 7, the display panel 10P may include a plurality of display elements for displaying an image.

Referring to FIG. 7, the display panel 10P may include the substrate 100, a display layer 200 arranged over the substrate 100, and a thin film encapsulation layer 300A, an input sensing layer 400, and an anti-reflection layer 600 on the display layer 200.

The substrate 100 may include glass or polymer resin. For example, the substrate 100 may include polymer resin such as polyethersulfone, polyacrylate, polyetherimide, polyethylene naphthalate, polyethylene terephthalate (“PET”), polyphenylene sulfide, polyarylate, polyimide (“PI”), polycarbonate, or cellulose acetate propionate. The substrate 100 including polymer resin may have flexible, rollable, or bendable characteristics. The substrate 100 may have a multi-layer structure including a layer including the above-described polymer resin and an inorganic layer (not shown).

A buffer layer 111 may be on the substrate 100. The buffer layer 111 may decrease or prevent penetration of foreign materials, moisture, or external air from below the substrate 100 and may provide a flat surface on the substrate 100. The buffer layer 111 may include an inorganic insulating material such as silicon oxide, silicon oxynitride, or silicon nitride and may have a single-layer or multi-layer structure including the above-described material.

The display layer 200 may be arranged over a front surface of the substrate 100, and a lower protective film 175 may be arranged on a rear surface of the substrate 100. The lower protective film 175 may support and protect the substrate 100. The lower protective film 175 may include an organic insulating material such as PET or PI. The lower protective film 175 may be attached to the rear surface of the substrate 100. An adhesive layer may be arranged between the lower protective film 175 and the substrate 100. Alternatively, the lower protective film 175 may be directly on the rear surface of the substrate 100, and in this case, no adhesive layer may be arranged between the lower protective film 175 and the substrate 100.

The display layer 200 may include the plurality of pixels P. The display layer 200 may include a display element layer including the organic light-emitting diode OLED, which is a display element, a circuit layer including a thin-film transistor TFT electrically connected to the organic light-emitting diode OLED, and an insulating layer IL. The organic light-emitting diode OLED may be electrically connected to the thin-film transistor TFT to constitute the pixel P.

The display layer 200 may be sealed by an encapsulation member. According to an embodiment, the encapsulation member may include the thin film encapsulation layer 300A as shown in FIG. 5. The thin film encapsulation layer 300A may include at least one inorganic encapsulation layer and at least one organic encapsulation layer. According to an embodiment, the thin film encapsulation layer 300A may include first and second inorganic encapsulation layers 310 and 330, and an organic encapsulation layer 320 therebetween.

In another embodiment, the encapsulation member may include an encapsulation substrate. The encapsulation substrate may face the substrate 100 with the display layer 200 therebetween. There may be a gap between the encapsulation substrate and the display layer 200. The encapsulation substrate may include glass. A sealant may be arranged between the substrate 100 and the encapsulation substrate, and the sealant may be arranged in the peripheral area NDA described above with reference to FIG. 3 or FIG. 4. The sealant arranged in the peripheral area NDA may prevent lateral penetration of moisture while surrounding the display area DA.

The input sensing layer 400 may obtain coordinate information according to an external input, for example, a touch event of an object such as a finger or a stylus pen. The input sensing layer 400 may include a touch electrode and trace lines connected to the touch electrode. The input sensing layer 400 may sense an external input in a mutual capacitance manner or a self-capacitance manner.

The input sensing layer 400 may be formed on the encapsulation member. Alternatively, the input sensing layer 400 may be separately formed and then be combined to the encapsulation member through the adhesive layer OCA such as an optically clear adhesive. According to an embodiment, the input sensing layer 400 may be directly formed on the thin film encapsulation layer 300A or the encapsulation substrate, and in this case, no adhesive layer may be arranged between the input sensing layer 400 and the thin film encapsulation layer 300A or the encapsulation substrate.

The anti-reflection layer 600 may decrease reflectance of light (external light) incident from the outside toward the display panel 10P.

According to an embodiment, the anti-reflection layer 600 may include an optical plate having a phase retarder and/or a polarizer. The phase retarder may be a film type or a liquid crystal coating type and may include a λ/2 phase retarder and/or a λ/4 phase retarder. The polarizer may also be a film type or a liquid crystal coating type. The phase retarder and the polarizer may further include a protective film. The film type polarizer may include an elongation-type synthetic resin film, and the liquid crystal coating type polarizer may include liquid crystals in a certain arrangement.

According to an embodiment, the anti-reflection layer 600 may include a filter plate including a black matrix and color filters. The filter plate may include color filters arranged for each pixel, a black matrix, and an overcoat layer.

According to an embodiment, the anti-reflection layer 600 may include a destructive interference structure. The destructive interference structure may include a first reflective layer and a second reflective layer arranged on different layers from each other. First reflected light and second reflected light reflected from the first reflective layer and the second reflective layer, respectively, may be subject to destructive interference, and accordingly, reflectance of external light may decrease.

The cover window 700 may be arranged above the display panel 10P. The cover window 700 may be a flexible window. The cover window 700 may protect the display panel 10P while bending easily according to an external force without causing cracks or the like. The cover window 700 may include glass, sapphire, or plastic. The cover window 700 may be, for example, ultra-thin glass (“UTG”) or colorless polyimide (“CPI”). According to an embodiment, the cover window 700 may have a structure in which a flexible polymer layer is arranged on one surface of a glass substrate, or may include only a polymer layer.

The cover window 700 may be arranged over the anti-reflection layer 600 of the display panel 10P and may be combined to the anti-reflection layer 600 through the adhesive layer OCA such as an optically clear adhesive.

According to an embodiment, although FIG. 7 shows the cover window 700 arranged over the anti-reflection layer 600, in another embodiment, positions of the anti-reflection layer 600 and the input sensing layer 400 may be switched, and in this case, the cover window 700 may be combined to the input sensing layer 400 through the adhesive layer OCA.

According to an embodiment, a thickness of the adhesive layer OCA may be about 50 micrometers (μm) to about 300 μm. In addition, according to an embodiment, a curing rate of the adhesive layer OCA may be about 95 percentages (%) or greater.

The adhesive layer OCA according to an embodiment may include an adhesive composition including (meth)acrylate having an alicyclic group, low-temperature glass transition (meth)acrylate, cross-linkable (meth)acrylate, and a thermal curing agent including an isocyanate-based compound.

According to an embodiment, when the adhesive composition is analyzed by nuclear magnetic resonance (“NMR”) spectroscopy, the content of the thermal curing agent may be about 55% or greater. The NMR spectroscopy is a method to measure a sample to be analyzed by using radio-frequency (“RF”) resonance, which causes rotational transition of atomic nuclei.

Particularly, the adhesive composition may include about 5 percentages by weight (wt %) to about 15 wt % of (meth)acrylate having an alicyclic group, about 15 wt % to about 25 wt % of low-temperature glass transition (meth)acrylate, about 5 wt % to about 15 wt % of cross-linkable (meth)acrylate, and about 55 wt % to about 65 wt % of a thermal curing agent including an isocyanate-based compound.

(Meth)acrylate having an alicyclic group may include, for example, at least one of isobornyl (meth)acrylate, bornyl (meth)acrylate, and cyclohexyl (meth)acrylate. As an example, (meth)acrylate having an alicyclic group may be isobornyl (meth)acrylate (IBOA). Particularly, (meth)acrylate having an alicyclic group may be (meth)acrylate in which a glass transition temperature of a homopolymer is 90° C. or higher, for example, 90° C. to 120° C. About 5 wt % to about 15 wt % of the (meth)acrylate having an alicyclic group may be included in the adhesive composition. In the above range, the adhesive composition may obtain an effect of increasing a peel strength and a modulus of the adhesive layer OCA and may secure stable foldability of the adhesive layer OCA.

Low-temperature glass transition (meth)acrylate may include, for example, at least one of benzyl (meth)acrylate, n-butyl (meth)acrylate, sec-butyl (meth)acrylate, cyclohexyl (meth)acrylate, iso-decyl (meth)acrylate, n-decyl (meth)acrylate, lauryl (meth)acrylate, 2-ethylhexyl (meth)acrylate, 2-(2-ethoxyethoxy)ethyl acrylate, n-hexyl acrylate, and n-octyl (meth)acrylate. As an example, the low-temperature glass transition (meth)acrylate may be 2-ethylhexyl (meth)acrylate (2-EHA). The low-temperature glass transition (meth)acrylate may be (meth)acrylate in which a glass transition temperature of a homopolymer is in a range of −100° C. to 40° C., in a range of −80° C. to 30° C., or in a range of −75° C. to 20° C. About 15 wt % to about 25 wt % of the low-temperature glass transition (meth)acrylate may be included in the adhesive composition.

Cross-linkable (meth)acrylate may be, for example, (meth)acrylate having an alkyl group. An alkyl group of the (meth)acrylate having an alkyl group may be linear or branched C1-C14 alkyl, specifically, a C1-C8 alkyl group. The (meth)acrylate having an alkyl group may include, specifically, one selected from the group including methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylhexyl (meth)acrylate, 2-ethylbutyl (meth)acrylate, octyl (meth)acrylate, isooctyl (meth)acrylate, isobornyl (meth)acrylate, isononyl (meth)acrylate, and a combination thereof. As an example, cross-linkable (meth)acrylate may be octyl (meth)acrylate (“OMA”). By using (meth)acrylate having an alkyl group having a carbon number in the above range, the adhesive composition may be adjusted to have proper adhesive properties. About 5 wt % to about 15 wt % of the cross-linkable (meth)acrylate may be included in the adhesive composition.

A thermal curing agent may include an isocyanate-based curing agent. The isocyanate-based curing agent may be, for example, at least one selected from the group including toluene diisocyanate, diphenylmethane diisocyanate, xylene diisocyanate, methylene diphenylmethane diisocyanate, isophorone diisocyanate (“IPDI”), cyclohexane diisocyanate, hexamethylene diisocyanate, and a combination thereof. As an example, a thermal curing agent may be isophorone diisocyanate (IPDI). About 55 wt % to about 65 wt % of the thermal curing agent may be included in the adhesive composition. The thermal curing agent may increase a cross-linking degree of an adhesive composition according to an embodiment and may easily control a tack and a peel strength to a required level.

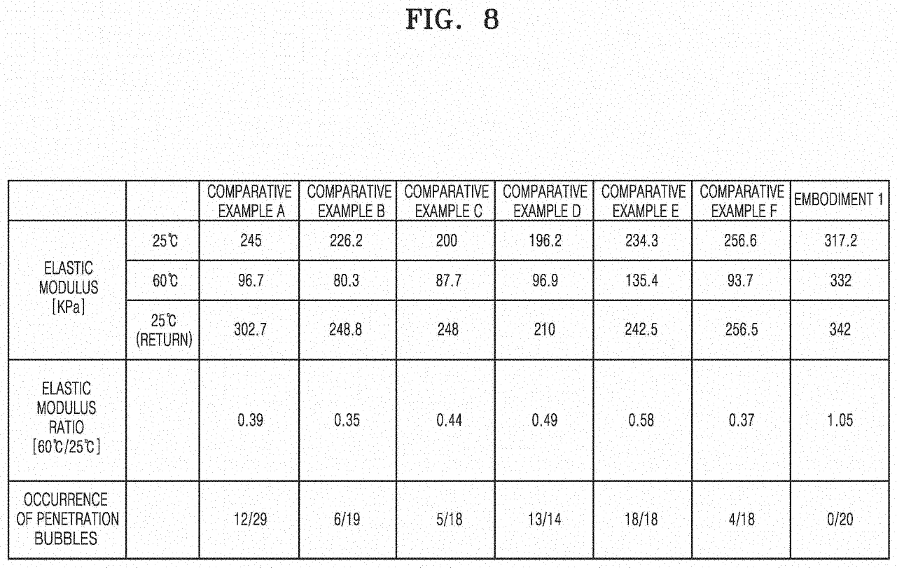

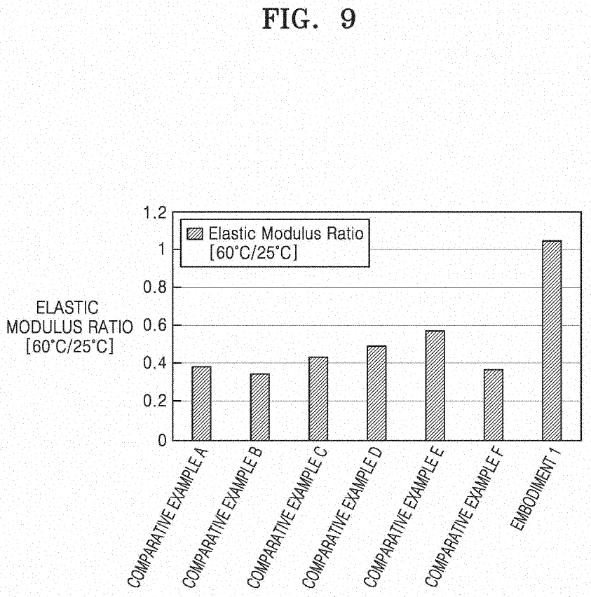

FIG. 8 is a table of measurement of an elastic modulus according to temperature and penetrating bubbles of an adhesive composition according to an embodiment and comparative examples. FIG. 9 is a graph showing an elastic modulus ratio according to temperature of an adhesive composition according to an embodiment and comparative examples.

According to an embodiment, an adhesive composition described herein may have a first elastic modulus at a first temperature and a second elastic modulus at a second temperature greater than the first temperature, and the second elastic modulus may be equal to the first elastic modulus or greater than the first elastic modulus. For example, when the first temperature is 25° C., and the second temperature is 60° C., a second elastic modulus at 60° C. may be equal to or greater than a first elastic modulus at 25° C. In general organic polymers, when the temperature increases from low to high temperature, properties become flexible, and the elastic modulus decreases. On the other hand, in an adhesive composition according to an embodiment, when the temperature increases from low to high temperature, rather, the elastic modulus may be constant or increase. That is, the adhesive composition may satisfy Equation 1 below.

$$1 \leq \frac{Second Elastic Modulus at 60 ° C .}{First Elastic Modulus at 25 ° C .} \qquad [ Equation 1 ]$$

Referring to FIG. 8, the elastic moduli of embodiment 1 and comparative examples A to F were comparatively measured. The elastic modulus was first measured at 25° C. according to autoclave process conditions, was measured by raising the temperature to 60° C. and then was measured by returning the temperature to 25° C. In this regard, 25° C. may be based on the temperature of room temperature.

An adhesive composition according to embodiment 1 may include about 5 wt % to about 15 wt % of (meth)acrylate having an alicyclic group, about 15 wt % to about 25 wt % of low-temperature glass transition (meth)acrylate, about 5 wt % to about 15 wt % of cross-linkable (meth)acrylate, and about 55 wt % to about 65 wt % of a thermal curing agent including an isocyanate-based compound. On the other hand, comparative examples A to F may be materials that do not satisfy at least some conditions of the above-described composition ratio.

Comparative example A had an elastic modulus of 245 kilopascals (KPa) at 25° C., and an elastic modulus of 96.7 KPa at 60° C., comparative example B had an elastic modulus of 226.2 KPa at 25° C. and an elastic modulus of 80.3 KPa at 60° C., and comparative example C had an elastic modulus of 200 KPa at 25° C. and an elastic modulus of 87.7 KPa at 60° C. Also, comparative example D had an elastic modulus of 196.2 KPa at 25° C. and an elastic modulus of 96.9 KPa at 60° C., comparative example E had an elastic modulus of 234.3 KPa at 25° C. and an elastic modulus of 135.4 KPa at 60° C., and comparative example F had an elastic modulus of 256.6 KPa at 25° C. and an elastic modulus of 93.7 KPa at 60° C.

As seen from the above results, in comparative examples A to F, the elastic modulus (second elastic modulus) at 60° C. was lower than the elastic modulus (first elastic modulus) at 25° C. It may be confirmed that, like general polymers, comparative examples A to F, which did not satisfy a composition ratio described herein, have flexible properties as the temperature increases and have decreased elastic moduli.

Embodiment 1 had an elastic modulus of 317.2 KPa at 25° C. and an elastic modulus of 332 KPa at 60° C. That is, in embodiment 1, contrary to the above comparative examples A to F, the elastic modulus rather increased as the temperature increases. It may be seen that the adhesive composition of Embodiment 1 has less flexible at a high temperature compared to a low temperature.

Referring to FIGS. 8 and 9 together, an elastic modulus ratio of a high temperature (e.g., 60° C.) compared to room temperature (e.g., 25° C.) was measured.

$$Elastic Modulus Ratio = \frac{Elastic Modulus at 60 ° C .}{Elastic Modulus at 25 ° C .}$$

It may be confirmed that comparative example A has an elastic modulus ratio of 0.39, comparative example B has an elastic modulus ratio of 0.35, comparative example C has an elastic modulus ratio of 0.44, comparative example D has an elastic modulus ratio of 0.49, comparative example E has an elastic modulus ratio of 0.58, and comparative example F has an elastic modulus ratio of 0.37, which are all less than 1. On the other hand, in embodiment 1, it may be confirmed that the elastic modulus ratio is 1.05.

In comparative examples A to F in which an elastic modulus ratio of a high temperature (e.g., 60° C.) compared to room temperature (e.g., 25° C.) is less than 1 as described above, in comparative example A, penetrating bubbles occurred in 12 out of 29 specimens, in comparative example B, penetrating bubbles occurred in 6 out of 19 specimens, in comparative example C, penetrating bubbles occurred in 5 out of 18 specimens, in comparative example D, penetrating bubbles occurred in 13 out of 14 specimens, in comparative example E, penetrating bubbles occurred in 18 out of 18 specimens, and in comparative example F, penetrating bubbles occurred in 4 out of 18 specimens.

Accordingly, in comparative examples A to F, a defect rate at which penetrating bubbles occur is about 22% to about 100%, which is not suitable as an adhesive composition. On the other hand, in embodiment 1 in which an elastic modulus ratio of a high temperature (e.g., 60° C.) compared to room temperature (e.g., 25° C.) is equal to or greater than 1, it may be confirmed that no penetrating bubbles occurred among 20 specimens.

An adhesive composition described herein may include, for example, materials of the following embodiment.

### Embodiment 1

An adhesive composition according to the present embodiment may include about 5 wt % to about 15 wt % of isobornyl (meth)acrylate (“IBOA”), about 15 wt % to about 25 wt % of 2-ethylhexyl (meth)acrylate (2-EHA), about 5 wt % to about 15 wt % of octyl (meth)acrylate (“OMA”), and about 55 wt % to about 65 wt % of isophorone diisocyanate (IPDI).

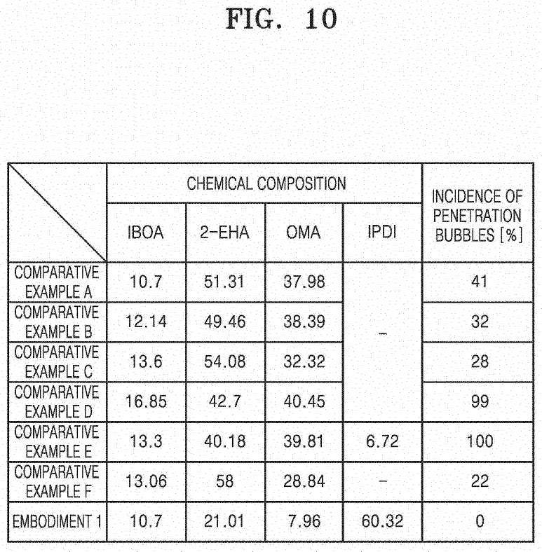

FIG. 10 is a table showing results of measuring the incidence of penetrating bubbles according to a composition ratio of an adhesive composition according to an embodiment and comparative examples.

In the table of FIG. 10, comparative examples A to F are disclosed. Comparative examples A to F of FIG. 10 refer to the same comparative examples as those of FIGS. 8 and 9 described above. Unlike embodiment 1, comparative examples A, B, C, D, and F do not include isophorone diisocyanate (IPDI). Comparative example E includes a trace amount of isophorone diisocyanate (IPDI). That is, comparative examples A to F include materials that do not satisfy at least one condition of the above-described composition ratio of embodiment 1.

Specifically, in comparative example A, 10.7 wt % of isobornyl (meth)acrylate (IBOA), 51.31 wt % of 2-ethylhexyl (meth)acrylate (2-EHA), and 37.98 wt % of octyl (meth)acrylate (OMA) are included, and the incidence of penetrating bubbles was about 41%. Also, in comparative example B, 12.14 wt % of isobornyl (meth)acrylate (IBOA), 49.46 wt % of 2-ethylhexyl (meth)acrylate (2-EHA), and 38.39 wt % of octyl (meth)acrylate (OMA) are included, and the incidence of penetrating bubbles was about 32%. Also, in comparative example C, 13.6 wt % of isobornyl (meth)acrylate (IBOA), 54.08 wt % of 2-ethylhexyl (meth)acrylate (2-EHA), and 32.32 wt % of octyl (meth)acrylate (OMA) are included, and the incidence of penetrating bubbles was about 28%. Also, in comparative example D, 16.85 wt % of isobornyl (meth)acrylate (IBOA), 42.7 wt % of 2-ethylhexyl (meth)acrylate (2-EHA), and 40.45 wt % of octyl (meth)acrylate (OMA) are included, and the incidence of penetrating bubbles was about 99%. Also, in comparative example F, 13.06 wt % of isobornyl (meth)acrylate (IBOA), 58 wt % of 2-ethylhexyl (meth)acrylate (2-EHA), and 28.84 wt % of octyl (meth)acrylate (OMA) are included, and the incidence of penetrating bubbles was about 22%.

Meanwhile, in comparative example E, 13.3 wt % of isobornyl (meth)acrylate (IBOA), 40.18 wt % of 2-ethylhexyl (meth)acrylate (2-EHA), 39.81 wt % of octyl (meth)acrylate (OMA), and 6.72 wt % of isophorone diisocyanate (IPDI) are included, and the incidence of penetrating bubbles was about 100%. It is worth noting that, unlike the above comparative examples A, B, C, D, and F, comparative example E includes isophorone diisocyanate (IPDI) but rather has a defect rate of 100%. Comparative example E includes isophorone diisocyanate (IPDI) but includes a trace amount as much as about 1/10 of that in embodiment 1. Such a result indicates that, in the case of including isophorone diisocyanate (IPDI), a composition ratio thereof works as a significant factor. It may be confirmed that, even if an adhesive composition includes isophorone diisocyanate (IPDI), when the adhesive composition does not satisfy the same weight ratio as in embodiment 1, the occurrence of penetrating bubbles rather increases and thus a defect rate increases.

An adhesive composition according to embodiment 1 of FIG. 10 includes, specifically, 10.7 wt % of isobornyl (meth)acrylate (IBOA), 21.01 wt % of 2-ethylhexyl (meth)acrylate (“2-EHA”), 7.96 wt % of octyl (meth)acrylate (OMA), and 60.32 wt % of isophorone diisocyanate (IPDI). That is, it was confirmed that the adhesive composition according to embodiment 1 includes 60 wt % or greater of isophorone diisocyanate (IPDI) and thus the incidence of penetrating bubbles is 0%.

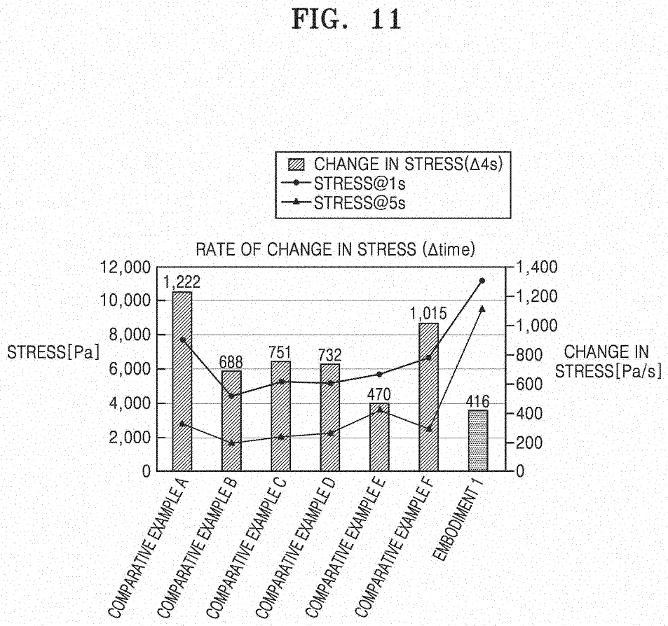

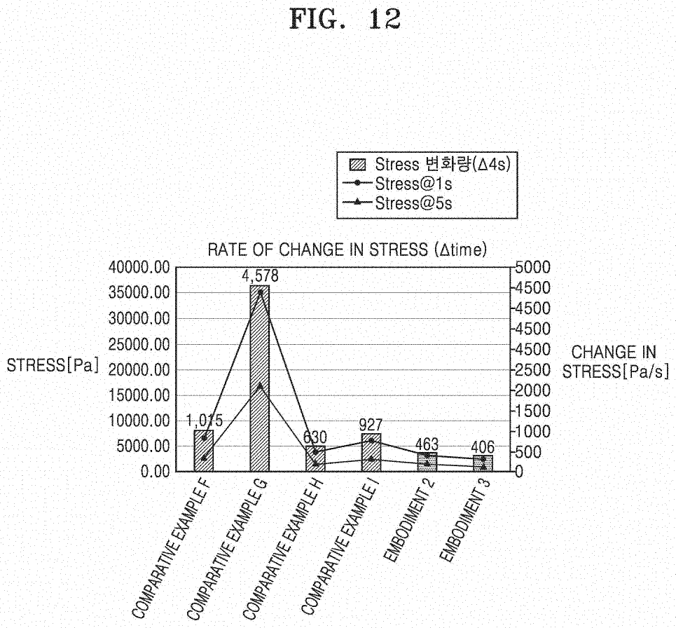

FIGS. 11 and 12 are graphs comparatively measuring changes in stress according to stress-relaxation characteristics of an adhesive composition according to an embodiment and comparative examples.

According to an embodiment, in an adhesive composition described herein, a change in stress between 1 second and 5 seconds according to stress-relaxation characteristics at 60° C. may be less than 470 pascals per second (Pa/s). Specifically, in the adhesive composition described herein, a change in stress between 1 second and 5 seconds according to stress-relaxation characteristics at 60° C. may be 463 Pa/s or less.

In the present description, “stress-relaxation” may be experimented with the same specimen as the above-described creep. Stress-relaxation characteristics are measurements of a resulting change in stress by giving the same amount of strain to the specimen. Specifically, a stress required to constantly maintain the strain when a 25% strain due to shear stress is given to the specimen for 10 minutes (600 seconds) is shown over time. A phenomenon in which, when an instantaneously applied strain is held constant in this way, an internal stress of an object decreases with the lapse of time is referred to as “stress-relaxation”. That is, when an instantaneous force is applied to a specimen, a stress required to constantly maintain the strain decreases over time, and “stress-relaxation” refers to a phenomenon in which, when an instantaneously applied strain is held constant in this way, an internal stress of an object decreases with the lapse of time.

In FIG. 11, stress-relaxation was measured for embodiment 1 and comparative examples A to F described above, and in FIG. 12, stress-relaxation was measured for other embodiments 2 and 3 and comparative examples F to I. For reference, comparative example F of FIG. 12 refers to the same material as comparative example F of FIG. 11, etc. Embodiments 2 and 3 and comparative examples F to I of FIG. 12 are all acrylic adhesive compositions.

In FIGS. 11 and 12, during a process of measuring stress-relaxation characteristics, each of a stress value at 1 second and a stress value at 5 seconds was measured, and a change in stress between 1 second and 5 seconds, that is, for 4 seconds, was measured. A change in stress may be represented as Equation 2 below.

$$Change in Stress ( Pa / s ) = \frac{\begin{matrix}Stress Value at 1 Second ( Pa ) - \\ Stress Value at 5 Seconds ( Pa )\end{matrix}}{4 ( s )} \qquad [ Equation 2 ]$$

Referring to FIG. 11, the left y-axis shows a stress value, and the right y-axis shows a change in stress (As) for 4 seconds. The change in stress was measured as 1222 Pa/s in comparative example A, 688 Pa/s in comparative example B, 751 Pa/s in comparative example C, 732 Pa/s in comparative example D, 470 Pa/s in comparative example E, and 1015 Pa/s in comparative example F. As described above with reference to FIG. 10, comparative examples A to F all turned out to have a defect regarding penetrating bubbles. Accordingly, as seen from the measurement results of comparative examples A to F, it may be confirmed that none of the cases in which the change in stress is 470 Pa/s or greater satisfy the condition regarding penetrating bubbles.

On the other hand, in an adhesive composition according to embodiment 1, the change in stress was measured as 416 Pa/s. As described above, in embodiment 1, it was confirmed that a defect rate regarding penetrating bubbles is 0%.

Referring to FIG. 12, the left y-axis shows a stress value, and the right y-axis shows a change in stress (Δs) for 4 seconds. The change in stress was measured as 4578 Pa/s in comparative example G, 630 Pa/s in comparative example H, 927 Pa/s in comparative example I, and 1015 Pa/s in comparative example F.

On the other hand, in an adhesive composition according to embodiment 2, the change in stress was measured as 463 Pa/s, and in an adhesive composition according to embodiment 3, the change in stress was measured as 406 Pa/s.

As a result of analysis through the results of FIGS. 11 and 12, it may be confirmed that, in an adhesive composition according to an embodiment, a change in stress between 1 second and 5 seconds should be less than 470 Pa/s, more specifically, 463 Pa/s or less. When a change in stress between 1 second and 5 seconds is 470 Pa/s or greater, for example, in comparative example E of FIG. 11, it may be confirmed that the incidence of penetrating bubbles is 100% as measured in FIGS. 9 and 10. Accordingly, it may be confirmed that an adhesive composition according to an embodiment has a critical significance when a change in stress between 1 second and 5 seconds is less than 470 Pa/s, more specifically, 463 Pa/s or less.

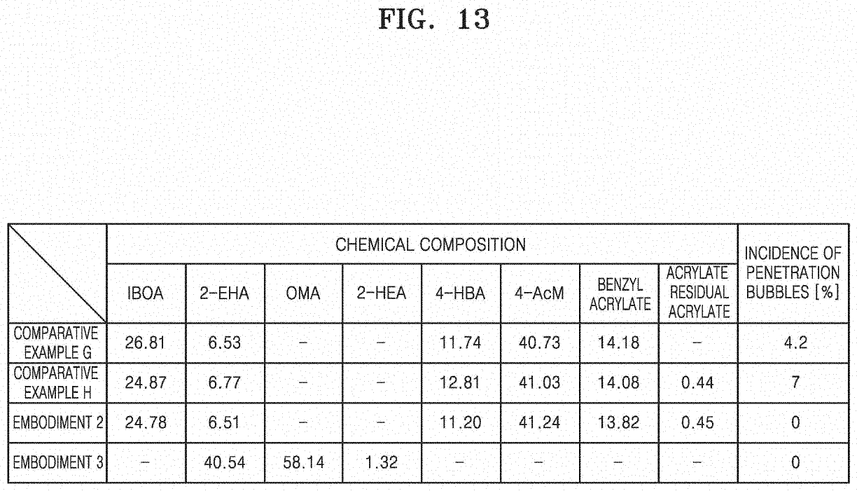

FIG. 13 is a table showing composition ratios of the embodiments and the comparative examples of FIG. 12.

Referring to FIG. 13, specifically, in comparative example G, 26.81 wt % of isobornyl (meth)acrylate (IBOA), 6.53 wt % of 2-ethylhexyl (meth)acrylate (2-EHA), 11.74 wt % of 4-hydroxybutyl (meth)acrylate (“4-HBA”), 40.73 wt % of 4-acryloyl morpholine (“4-AcM”), and 14.18 wt % of benzyl acrylate are included, and the incidence of penetrating bubbles was about 4.2%. Also, in comparative example H, 24.87 wt % of isobornyl (meth)acrylate (IBOA), 6.77 wt % of 2-ethylhexyl (meth)acrylate (2-EHA), 12.81 wt % of 4-hydroxybutyl (meth)acrylate (4-HBA), 41.03 wt % of 4-acryloyl morpholine (4-AcM), 14.08 wt % of benzyl acrylate, and a residual acrylate-based material are included, and the incidence of penetrating bubbles was about 7%.

On the other hand, embodiment 2 includes 24.78 wt % of isobornyl (meth)acrylate (IBOA), 6.51 wt % of 2-ethylhexyl (meth)acrylate (2-EHA), 11.20 wt % of 4-hydroxybutyl (meth)acrylate (4-HBA), 41.24 wt % of 4-acryloyl morpholine (4-AcM), 13.82 wt % of benzyl acrylate, and a residual acrylate-based material, and embodiment 3 includes 40.54 wt % of 2-ethylhexyl (meth)acrylate (2-EHA), 58.14 wt % of octyl (meth)acrylate (OMA), and 1.32 wt % of 2-hydroxyethyl acrylate (2-HEA). In this regard, in embodiments 2 and 3, the incidence of penetrating bubbles was 0%.

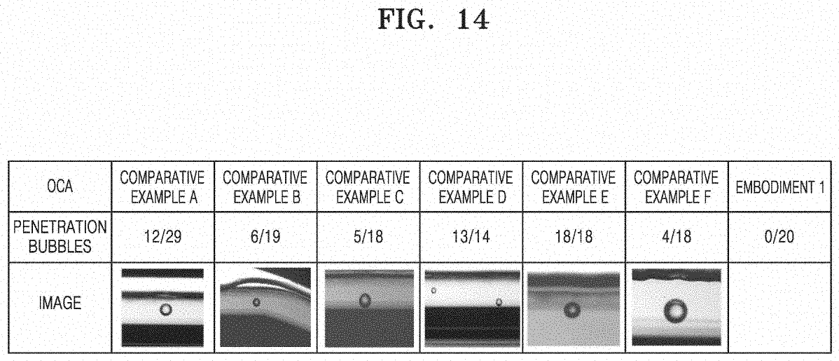

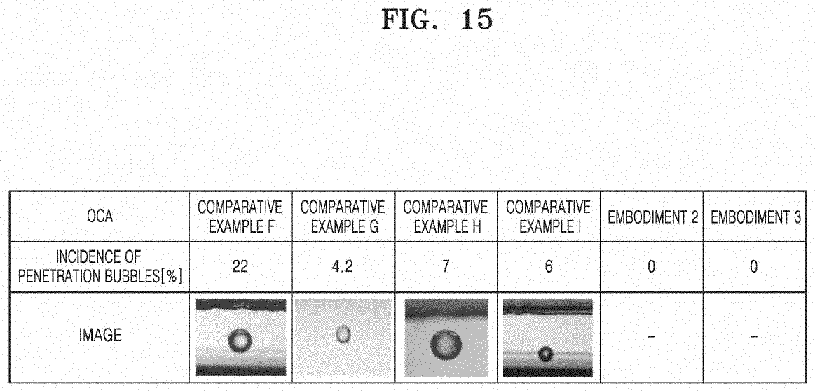

As shown in FIGS. 12 and 13 described above, in the case of adhesive compositions of embodiments 2 and 3, it may be confirmed that, when a change in stress between 1 second and 5 seconds (for 4 seconds) is less than 470 Pa/s, that is, 463 Pa/s or less, penetrating bubbles did not occur. FIG. 14 is a table showing penetrating bubbles and images according to the experimental result of FIG. 11, and FIG. 15 is a table showing penetrating bubbles and images according to the experimental result of FIG. 12.

Referring to FIG. 14, in each of comparative examples A to F, when 14 to 29 samples were tested, the number of defective samples in which penetrating bubbles occurred was 4 to 18. This may mean that the incidence of defects due to penetrating bubbles is about 22% to about 100% in terms of percentage. In comparative examples A to F, it may be confirmed that, as shown in the images of FIG. 14, circular penetrating bubbles occurred after an autoclave process. On the other hand, in embodiment 1, it may be confirmed that penetrating bubbles did not occur.

Referring to FIG. 15, in comparative examples F to I, the incidence of penetrating bubbles was about 22%, about 4.2%, about 7%, and about 6%, respectively, whereas in embodiments 2 and 3, the incidence of penetrating bubbles was 0%. In comparative examples F to I, it may be confirmed that, as shown in the images of FIG. 15, circular penetrating bubbles occurred after an autoclave process.

The display apparatus 1, 1′, and 1″ described with reference to the accompanying drawings is an apparatus for displaying a moving image or a still image, and may be used as the display screen of not only portable electronic devices, such as a mobile phone, a smart phone, a tablet personal computer (“PC”), a mobile communication terminal, an electronic notebook, an e-book, a portable multimedia player (PMP), a navigation system, and an ultra-mobile PC (“UMPC”), but also various products, such as a television, a laptop, a monitor, and a billboard. In addition, a display apparatus according to an embodiment may be used in wearable devices, such as a smart watch, a watch phone, a glasses-type display, and a head-mounted display (“HMD”). In addition, a display apparatus according to an embodiment may be used as a car's instrument cluster, a center information display (“CID”) arranged on a car's center fascia or dashboard, a room mirror display replacing a car's side mirror, or a display arranged on the back of a front seat as entertainment for a car's rear seat.

According to one or more of the above embodiments, an adhesive composition having improved reliability with respect to penetrating bubbles and a display apparatus including the adhesive composition may be provided. However, the disclosure is not limited by such an effect.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An adhesive composition comprising:
(meth)acrylate having an alicyclic group;
(meth)acrylate having a glass transition temperature of 40 degrees in Celsius (° C.) or less;
cross-linkable (meth)acrylate; and
a thermal curing agent comprising an isocyanate-based compound,
wherein the adhesive composition has a first elastic modulus at a first temperature and a second elastic modulus at a second temperature greater than the first temperature, and the second elastic modulus is equal to or greater than the first elastic modulus.

2. The adhesive composition of claim 1, wherein an amount of the (meth)acrylate having the alicyclic group is about 5 percentages by weight (wt %) to about 15 wt %.

3. The adhesive composition of claim 1, wherein an amount of the (meth)acrylate having the glass transition temperature of about 40° C. or less is about 15 wt % to about 25 wt %.

4. The adhesive composition of claim 1, wherein an amount of the cross-linkable (meth)acrylate is about 5 wt % to about 15 wt %.

5. The adhesive composition of claim 1, wherein an amount of the thermal curing agent is about 55 wt % to about 65 wt %.

6. The adhesive composition of claim 1, wherein a ratio between the first elastic modulus at about 25° C. and the second elastic modulus at about 60° C. satisfies Equation below:
Second elastic modulus/first elastic modulus≥1. [Equation]

7. The adhesive composition of claim 1, wherein a change in stress between about 1 second and about 5 seconds according to stress-relaxation characteristics at about 60° C. is less than about 470 pascals per second (Pa/s).

8. The adhesive composition of claim 1, wherein the cross-linkable (meth)acrylate is a (meth)acrylate monomer having an alkyl group of 1 to 12 carbon atoms.

9. The adhesive composition of claim 1, wherein the isocyanate-based compound comprises at least one of an aliphatic isocyanate-based compound, an alicyclic isocyanate-based compound, and an aromatic isocyanate-based compound.

10. The adhesive composition of claim 1, wherein a curing rate of the adhesive composition is about 95 percentages (%) or greater.

11. A display apparatus comprising:
a display panel;
a cover window above the display panel; and
an adhesive layer between the display panel and the cover window,
wherein the adhesive layer comprises:
(meth)acrylate having an alicyclic group;
(meth)acrylate having a glass transition temperature of about 40° C. or less;
cross-linkable (meth)acrylate; and
a thermal curing agent comprising an isocyanate-based compound,
wherein the adhesive layer has a first elastic modulus at a first temperature and a second elastic modulus at a second temperature greater than the first temperature, and the second elastic modulus is equal to or greater than the first elastic modulus.

12. The display apparatus of claim 11, wherein an amount of the (meth)acrylate having the alicyclic group is 5 about wt % to about 15 wt %.

13. The display apparatus of claim 11, wherein an amount of the (meth)acrylate having the glass transition temperature of about 40° C. or less is about 15 wt % to about 25 wt %.

14. The display apparatus of claim 11, wherein an amount of the cross-linkable (meth)acrylate is about 5 wt % to about 15 wt %.

15. The display apparatus of claim 11, wherein an amount of the thermal curing agent is about 55 wt % to about 65 wt %.

16. The display apparatus of claim 11, wherein, in the adhesive layer, a ratio between the first elastic modulus at about 25° C. and the second elastic modulus at about 60° C. satisfies Equation below:
Second elastic modulus/first elastic modulus≥1. [Equation]

17. The display apparatus of claim 11, wherein, in the adhesive layer, a change in stress between about 1 second and about 5 seconds according to stress-relaxation characteristics at about 60° C. is less than about 470 Pa/s.

18. The display apparatus of claim 11, wherein a thickness of the adhesive layer is about 50 micrometers (μm) to about 300 μm.

19. The display apparatus of claim 11, wherein a curing rate of the adhesive layer is about 95% or greater.

20. An adhesive composition that has:
a first elastic modulus at a first temperature and a second elastic modulus at a second temperature greater than the first temperature,
wherein the second elastic modulus is equal to or greater than the first elastic modulus.

21. The adhesive composition of claim 20, wherein the first temperature is about 25° C., and the second temperature is about 60° C.

22. The adhesive composition of claim 20, wherein a change in stress between about 1 second and about 5 seconds according to stress-relaxation characteristics at about 60° C. is less than about 470 Pa/s.

23. The adhesive composition of claim 20, wherein the adhesive composition is urethane-based or acrylic-based.
